(19) United States
(12) Patent Application Publication
(10) Pub. No.: US 2026/0320106 A1
(43) Pub. Date: Oct. 15, 2026

(54) SYSTEMS AND METHODS FOR ENHANCING MEDIA FILE SEARCHABILITY

(71) Applicant: Verizon Patent and Licensing Inc., Basking Ridge, NJ (US)

(72) Inventor: Ravi Kiran TUMMALA, Hyderabad (IN)

(73) Assignee: Verizon Patent and Licensing Inc., Basking Ridge, NJ (US)

(21) Appl. No.: 19/179,333

(22) Filed: Apr. 15, 2025

(51) Int. Cl. G06F 16/432; G06F 16/44

(52) U.S. Cl. CPC G06F 16/433; G06F 16/44

(57) ABSTRACT

A device may receive media files, and may divide the media files into media samples based on a sampling rate. The device may utilize a language model to generate media summaries based on the media samples, and may assign time windows and identifiers to the media summaries. The device may map the media summaries and the time windows as media vectors in a vector space of a vector model, and may receive an input query. The device may utilize the language model to generate a summarized query based on the input query, and may map the summarized query as a query vector in the vector space. The device may identify media vectors that are closest to the query vector in the vector space, may determine media summaries that correspond to the identifier media vectors, and may generate a response to the input query based on the determined media summaries.

### BACKGROUND

Search functionality is integral to navigating the ever-growing expanse of digital information, particularly with media files, such as audio and video content.

### BRIEF DESCRIPTION OF THE DRAWINGS

FIGS. 1A-1I are diagrams of an example associated with enhancing media file searchability.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIGS. 5 and 6 are flowcharts of example processes for enhancing media file searchability.

### DETAILED DESCRIPTION OF EXAMPLE EMBODIMENTS

The following detailed description of example implementations refers to the accompanying drawings. The same reference numbers in different drawings may identify the same or similar elements.

Users (e.g., Internet users, software developers, customer service representatives, and/or the like) may rely on search capabilities to find specific information within large media files swiftly and efficiently. Current search systems are unable to effectively search within audio and video content. Thus, users often have to listen to an entire audio file or watch an entire video file to locate relevant sections, leading to increased time spent on tasks and decreased productivity. Support teams, development teams, and other technical teams, in particular, struggle to quickly grasp the context of customer service interactions from lengthy audio or video recordings, which hinders their ability to effectively address issues. The software development teams must sift through vast amounts of irrelevant content to identify critical segments that require attention. Thus, current techniques for searching audio and video content consume computing resources (e.g., processing resources, memory resources, communication resources, and/or the like), networking resources, and/or other resources associated with requiring users to listen to an entire audio file or watch an entire video file to identify relevant sections, failing to identify relevant sections of audio and video content, handling poor user experience associated with requiring users to listen to an entire audio file or watch an entire video file to identify relevant sections, and/or the like.

Some implementations described herein provide a search system that enhances media file searchability. For example, the search system may receive media files that include audio files and video files, and may divide the media files into media samples based on a sampling rate. The search system may utilize a language model to generate media summaries based on the media samples, and may assign time windows and identifiers to the media summaries. The search system may map the media summaries and the time windows as media vectors in a vector space of a vector model, and may receive an input query from a user device. The search system may utilize the language model to generate a summarized query based on the input query, and may map the summarized query as a query vector in the vector space of the vector model. The search system may identify one or more of the media vectors that are closest to the query vector in the vector space of the vector model, and may determine one or more of the media summaries that correspond to the one or more of the media vectors. The search system may expand one or more of the time windows associated with the one or more of the media summaries to identify additional media summaries, and may combine the one or more of the media summaries and the additional media summaries to generate a response to the input query. The search system may provide the response to the user device.

In this way, the search system enhances media file searchability. For example, the search system may utilize artificial intelligence models, including LLMs and vector models, to provide a more nuanced contextual understanding of audio and video content, without requiring a user to search through the entire audio and video content. The search system may provide semantic search capabilities that improve a precision of identifying specific phrases, dialogues, or texts within media files. The search system may handle various forms of queries and may refine search techniques based on content form. The search system may be applied across multiple industries for purposes such as competitive intelligence, e-learning, and content moderation. The search system may optimize search operations and may minimize the need for manual intervention in media file analysis. Thus, the search system may conserve computing resources, networking resources, and/or other resources that would have otherwise been consumed by requiring users to listen to an entire audio file or watch an entire video file to identify relevant sections, failing to identify relevant sections of audio and video content, handling poor user experience associated with requiring users to listen to an entire audio file or watch an entire video file to identify relevant sections, and/or the like.

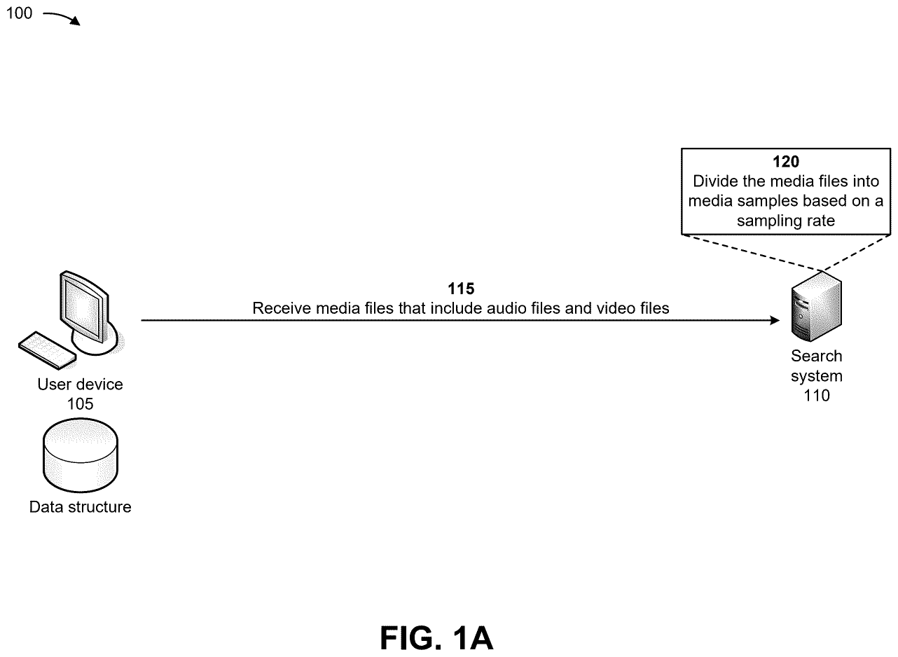

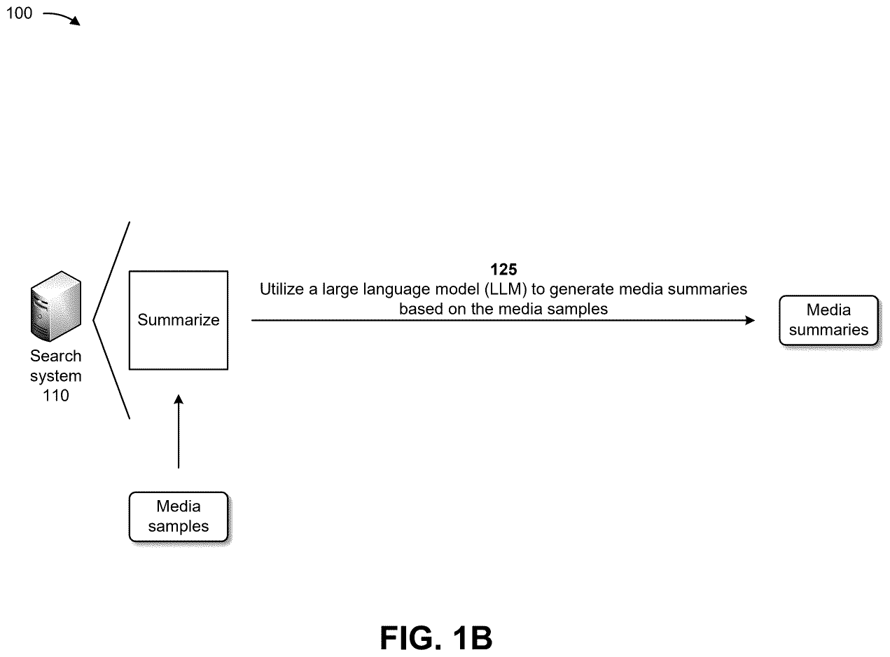

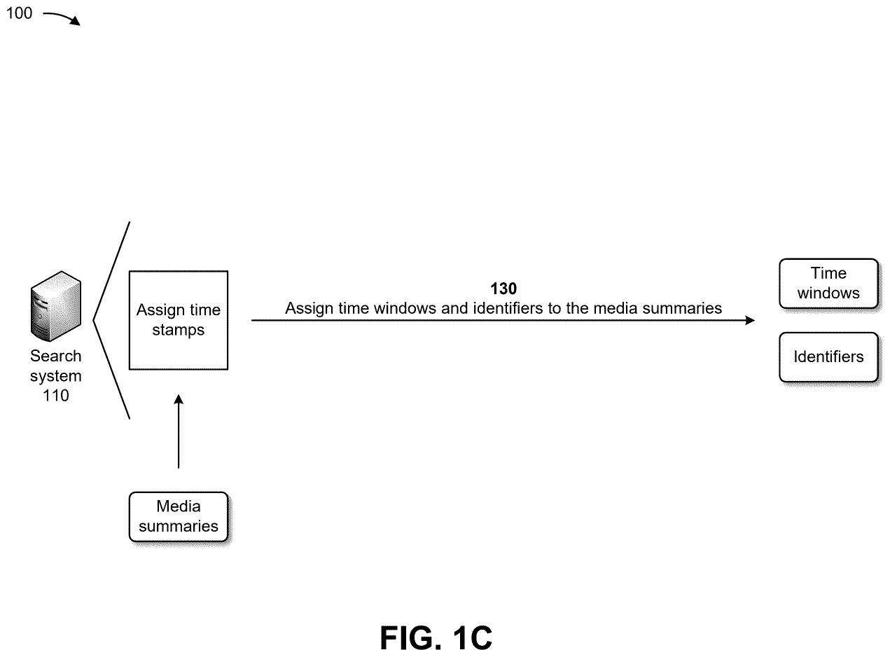

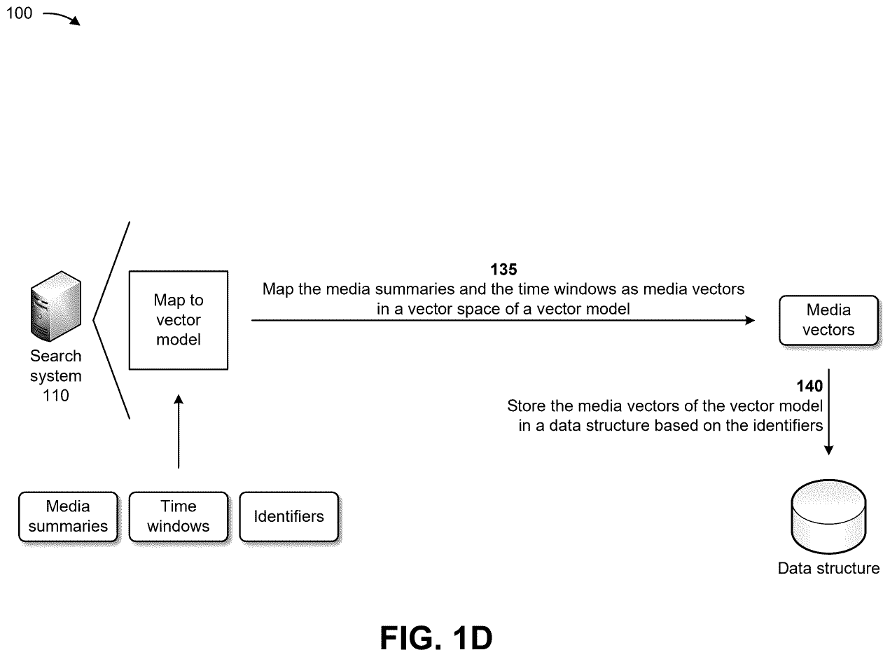

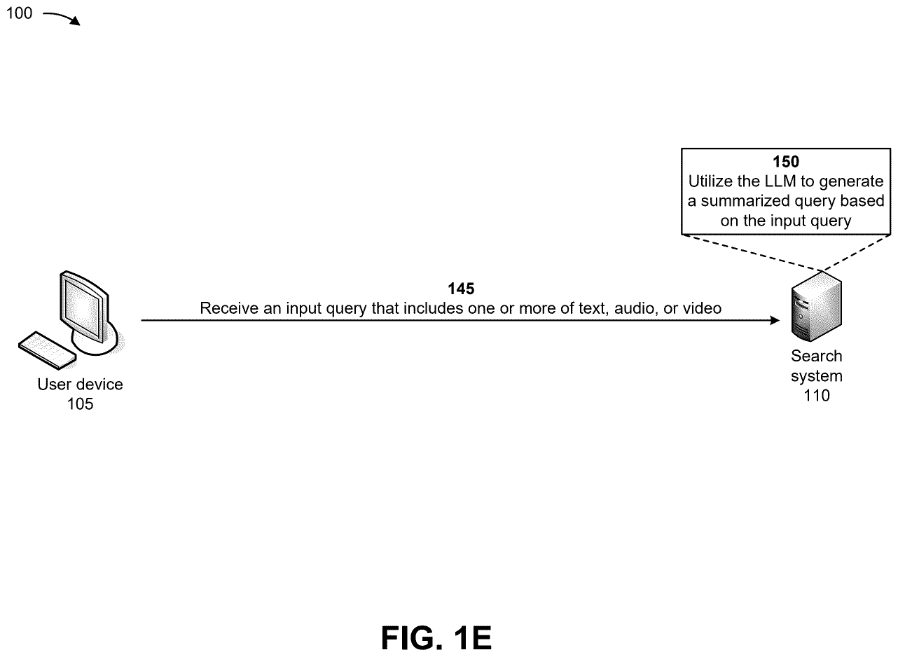

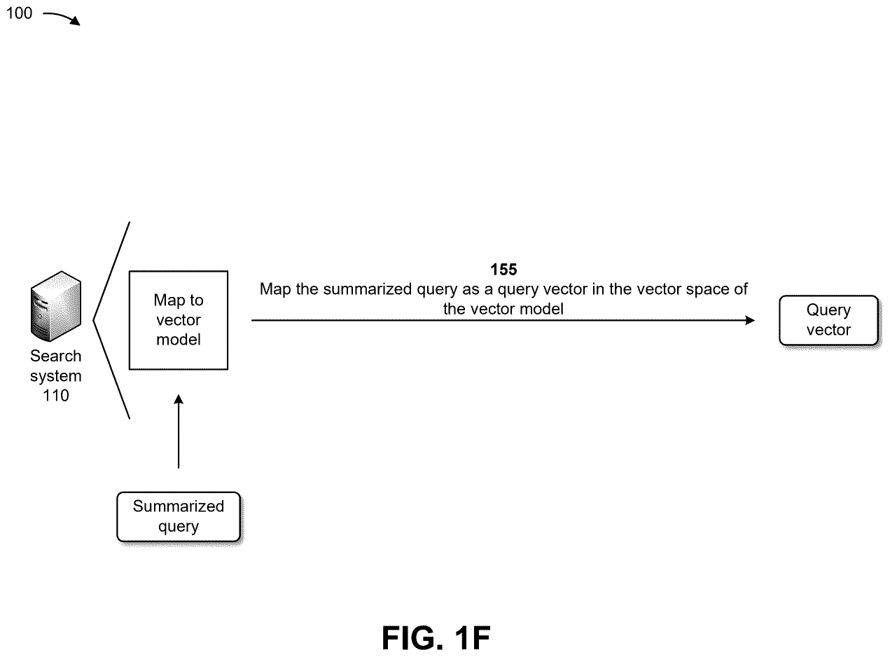

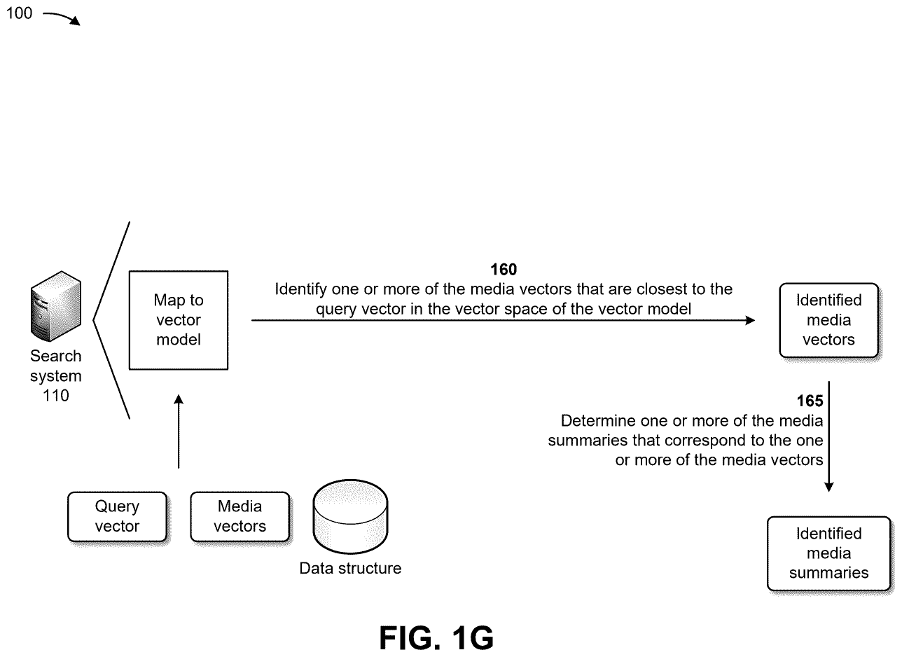

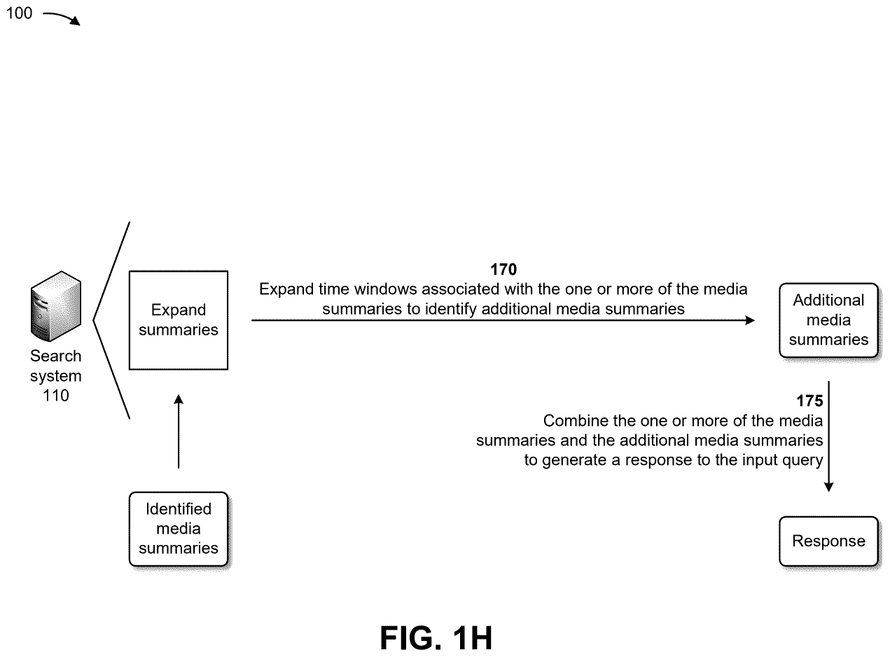

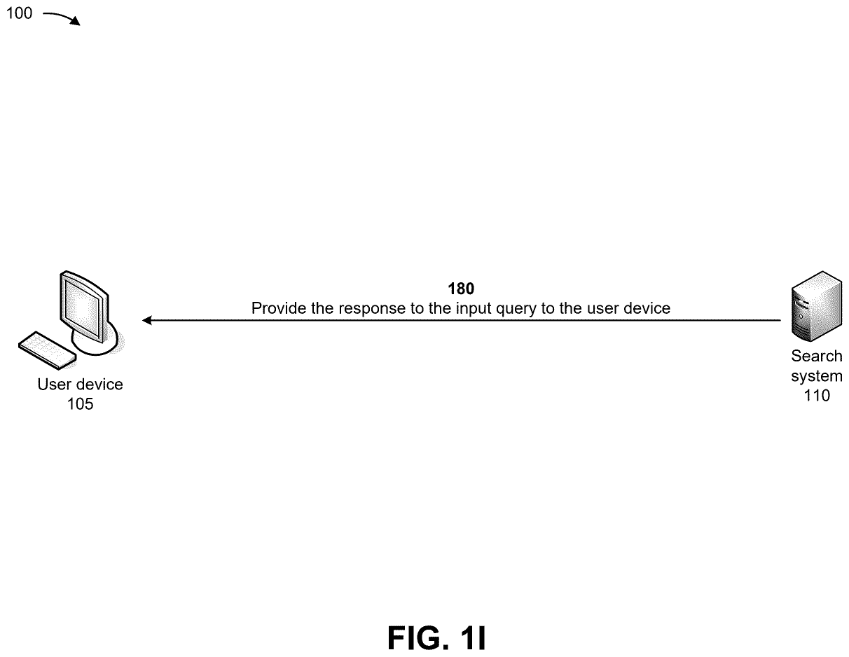

FIGS. 1A-1I are diagrams of an example 100 associated with enhancing media file searchability. As shown in FIGS. 1A-1I, the example 100 includes a user device 105 associated with a search system 110. The search system 110 may include a system that enhances media file searchability. Further details of the user device 105 and the search system 110 are provided elsewhere herein. Although implementations described herein depict a single user device 105, in some implementations, the search system 110 may be associated with multiple user devices 105.

As shown in FIG. 1A, and by reference number 115, the search system 110 may receive media files that include audio files and video files. For example, the search system 110 may be associated with a data structure (e.g., a database, a table, a list, and/or the like). The data structure may store media files (e.g., the audio files and video files) that are collected over time. For example, various forms of media files may be stored in the data structure, such as customer service interactions, e-learning sessions, competitive intelligence videos, and/or the like. The search system 110 may periodically receive the media files from the data structure, may continuously receive the media files from the data structure, may receive the media files from the data structure based on requesting the media files, and/or the like. Additionally, or alternatively, the search system 110 may receive media files in real-time or in batch mode, depending on the application requirements and user preferences. For example, the search system 110 may receive live streaming content or may process bulk uploads during off-peak hours.

In some implementations, the user device 105 may cause the data structure to provide the media files to the search system 110. In some implementations, the search system 110 may receive the media files from the user device 105. The media files may include audio files, video files, and multimedia files (e.g., streaming media content, such as live broadcasts or webinars) that are received from various sources, such as user devices, cloud storage, or remote servers.

As further shown by FIG. 1A, and by reference number 120, the search system 110 may divide the media files into media samples based on a sampling rate. For example, the search system 110 may divide the media files into smaller, more manageable chunks of content at defined intervals (e.g., based on the sampling rate, such as every minute, every two minutes, and/or the like). Dividing the media files into the media samples may provide for more efficient processing and analysis by components of the search system 110 (e.g., an LLM for summarizing the media files). The search system 110 may adjust the sampling rate based on various factors, including a nature of the media files and specific requirements of an application, to optimize an accuracy and efficiency of a search process by the search system 110. In some implementations, the search system 110 may divide the media files into the media samples based on a user-defined sampling rate. This may enable users to specify a granularity of the segmentation of the media files.

Additionally, or alternatively, the search system 110 may divide the media files into media samples of varying lengths, such as thirty (30) seconds, one (1) minute, five (5) minutes, and/or the like, based on a dynamic sampling rate adjusted by a machine learning model (e.g., a reinforcement learning model). This flexibility may enhance the adaptability of the search system 110 to different types of media content and user preferences. The reinforcement learning model may utilize an agent to learn to make decisions by performing actions in an environment to maximize cumulative rewards. The agent may receive feedback from the environment in the form of rewards or penalties based on the actions taken by the agent. Over time, the agent uses this feedback to learn a policy for selecting actions that will maximize the total reward. Additionally, or alternatively, the search system 110 may generate the media samples based on specific events or markers within the media files, such as scene changes in video files or pauses in audio files. This may ensure that the segmentation is contextually relevant and improves the effectiveness of subsequent analysis by the search system 110.

As shown by FIG. 1B, and by reference number 125, the search system 110 may utilize a language model (e.g., a large language model (LLM) or a small language model (SLM)) to generate media summaries based on the media samples. For example, the search system 110 may process the media samples, with the LLM, to create the media summaries that provide concise summaries of content within each media sample. In some implementations, the search system 110 may utilize a prompt to process the media samples with the language model (e.g., the LLM). For example, a first prompt may include “please listen to the two minute audio and identify the major segments covered in it. Provide a structured JSON format, which includes timestamps for the start and end of each section and summarize the content briefly in 1-2 sentences.” A second prompt may include “provide a detailed, yet concise summary of the audio within the media in a structured JSON format. The summary should include the title, duration, key points with timestamps, and a concise summary of each point.” In such examples, the second prompt may provide improved results of the first prompt, but may take more time to generate than the first prompt.

In some implementations, the LLM may analyze the audio and/or video data within each media sample to extract key information, and may generate a media summary that accurately reflects the extracted key information. The LLM may utilize natural language processing techniques to understand and summarize spoken language within the audio and/or video data of the media samples. In some implementations, the LLM may be trained on a diverse set of audio and video data to improve an ability of the LLM to generate accurate and relevant summaries across different types of media content. For example, the LLM may utilize contextual clues and semantic understanding to create media summaries that are brief, meaningful, and representative of the original content (e.g., the media samples). This may significantly enhance the efficiency of subsequent search processes by providing a structured and searchable format for the media files.

In some implementations, the LLM may include a transformer-based model, such as GPT-3, which has been pre-trained on a diverse corpus of text data. The LLM may be fine-tuned using a dataset specific to media file content, including transcripts of audio and video files. The fine-tuning process may include supervised learning where the LLM is trained to predict the next word in a sequence based on the context provided by the preceding words. The training dataset may include pairs of media samples and their corresponding summaries, which are used to adjust the weights of a neural network to optimize performance in generating accurate and relevant media summaries.

As shown in FIG. 1C, and by reference number 130, the search system 110 may assign time windows and identifiers to the media summaries. For example, the search system 110 may process each media summary, and may allocate a time window that corresponds to the portion of the media file from which the media summary was generated. The time windows may represent intervals of time within the media file, such as start and end times, that delineate the content summarized by the LLM. Additionally, the search system 110 may assign unique identifiers to each media summary, which serve as references for the time windows. This assignment of time windows and identifiers allows for precise indexing and retrieval of the media summaries during search operations. The identifiers may be used to link the media summaries with their respective time windows, facilitating efficient mapping and query handling. For example, if a video is twelve (12) minutes in duration and the sampling rate is two (2) minutes, the search system may generate six (6) media samples and six (6) corresponding media summaries. In such an example, the search system 110 may assign six (6) time slots and six (6) identifiers to the corresponding six (6) media summaries.

As shown by FIG. 1D, and reference number 135, the search system 110 may map the media summaries and the time windows as media vectors in a vector space of a vector model. For example, the search system 110 may process the media summaries and the corresponding time windows, with the vector model, to create media vectors that represent the summarized content within a structured vector space. When mapping the media summaries and the time windows as media vectors, the search system 110 may associating the media summaries and time windows with numerical representations that can be analyzed and compared within the vector model. The vector space may provide for efficient retrieval and comparison of media content based on contextual and semantic similarities.

A vector model, also known as a vector space model, may include a mathematical framework used to represent text documents, words, or other types of data as vectors in a multi-dimensional space. In vector model, each dimension may correspond to a feature or attribute of the data, and a position of a vector in this space may capture relationships and similarities between different data points. By converting data into vectors, the vector model may enable efficient comparison and analysis based on geometric properties like distance and direction, facilitating tasks such as semantic search and contextual understanding. In some implementations, the vector model may be an unsupervised machine learning model. An unsupervised machine learning model may be used to analyze and interpret data without the need for labeled training data. Unlike supervised learning, where the machine learning model is trained on a dataset containing input-output pairs, an unsupervised machine learning model may work with data that has no predefined labels or categories. A goal of an unsupervised machine learning model is to uncover hidden patterns, structures, or relationships within the data.

Common techniques may include clustering, where the unsupervised machine learning model may group similar data points together, and dimensionality reduction, where the unsupervised machine learning model reduces a number of features while preserving essential information.

In some implementations, the vector model may include an unsupervised machine learning model based on word embeddings. The vector model may convert each media summary into a vector representation by averaging word embeddings of words in the media summary. The vector space may include a multi-dimensional space where each dimension corresponds to a feature extracted from the media summaries. The vector model may be trained using a large corpus of text data to capture semantic relationships between words. The training my include minimizing a loss function that measures the difference between the predicted and actual word embeddings for a given context.

As further shown by FIG. 1D, and reference number 140, the search system 110 may store the media vectors of the vector model in a data structure based on the identifiers. For example, the search system 110 may store the media vectors, along with the unique identifiers, in the data structure to facilitate quick access and retrieval during search operations. The identifiers may link the media vectors to the corresponding media summaries and time windows, ensuring that the search system 110 can accurately reference and retrieve the relevant portions of the media files during query processing. This data structure may enhance an ability of the search system 110 to perform rapid and precise searches across large volumes of media content.

As shown in FIG. 1E, and by reference number 145, the search system 110 may receive an input query that includes one or more of text, audio, or video. For example, a user of the user device 105 may cause the user device to provide the input query to the search system 110, and the search system 110 may receive the input query from the user device 105. The input query may be associated with a specific search request, such as finding particular information within the media files. The input query may be received in various forms, such as text entered by the user, an audio recording, or a video recording. This flexibility in input types allows users to search media content using different methods depending on their preferences or a context of a search.

In some implementations, the search system 110 may process the input query using natural language processing techniques to identify key elements of the query. This may involve analyzing the input query to extract important keywords and phrases that may be necessary for searching the media files. Additionally, or alternatively, the search system 110 may convert the input query (e.g., whether the input query is text, audio, or video) into a uniform format suitable for further processing by the search system 110. For example, the search system 110 may standardize the query input into a specific format that can be efficiently analyzed and compared against the media files. Additionally, or alternatively, the search system 110 may preprocess the input query (e.g., by cleaning and normalizing the input query) before further analysis. This preprocessing of the input query may include removing noise, correcting errors, and ensuring consistency in the input query, thereby enhancing the accuracy of the subsequent search operations. Additionally, or alternatively, the input query may include metadata, such as timestamps or context indicators, to enhance the search accuracy within the media files. The metadata may provide additional context that enables the search system 110 to better understand and locate the relevant portions of the media files.

As further shown in FIG. 1E, and by reference number 150, the search system 110 may utilize the LLM to generate a summarized query based on the input query. For example, the search system 110 may process the input query, with the LLM, to create the summarized query that captures an intent of the input query. The LLM may analyze content of the input query, may extract key information, and may generate a concise representation of the input query (e.g., the summarized query) based on the key information. The search system 110 may utilize the summarized query to perform more efficient and accurate search operations within the media files. The LLM may ensure that the summarized query is contextually relevant and optimized for the search process, improving the precision and speed of identifying relevant media content. Additionally, or alternatively, the search system 110 may generate the summarized query generated based on extracting keywords, phrases, or contextual information from the input query.

Additionally, or alternatively, the LLM may refine the input query and generate the summarized query by removing redundancies from the input query and focusing on the most pertinent information for the search. Additionally, or alternatively, the search system 110 may utilize a hierarchical summarization approach to generate a multi-layered summarized query that captures various implementations of the input query. This may include creating different layers of summarization, each representing a different level of detail, which can be used to perform a more comprehensive search. Additionally, or alternatively, the search system 110 may enhance the summarized query with additional context or related concepts derived from a knowledge base of the LLM. This enhancement may provide a richer and more informed query, improving the likelihood of retrieving relevant media content.

As shown in FIG. 1F, and by reference number 155, the search system 110 may map the summarized query as a query vector in the vector space of the vector model. For example, the search system 110 may convert the summarized query into a numerical representation (e.g., the query vector) that can be analyzed and compared within the vector space of the vector model. The search system 110 may convert the summarized query into the query vector by transforming key elements and contextual information from the summarized query into a vector format suitable for use in the vector space. The vector space may enable the search system 110 to perform efficient and accurate comparisons between the summarized query and the media vectors, facilitating the identification of relevant media summaries. In some implementations, the search system 110 may process the summarized query, with the vector model, to generate the query vector in the vector space.

As shown in FIG. 1G, and by reference number 160, the search system 110 may identify one or more of the media vectors that are closest to the query vector in the vector space of the vector model, based on one or more similarity measures. For example, the search system 110 may retrieve the media vectors from the data structure, and may compare the query vector and the media vectors in the vector space. In some implementations, the search system 110 may compare the query vector and the media vectors by calculating distances (e.g., Euclidean distances) between the query vector and the media vectors in the vector space. The search system 110 may identify the one or more of the media vectors that have the smallest Euclidean distances to the query vector, since the smallest Euclidean distances may indicate the closest contextual matches to the summarized query. In some implementations, the search system 110 may identify the one or more of the media vectors that are closest to the query vector by calculating the Euclidean distances between the query vector and the media vectors in the vector space, and determining one or more of the Euclidean distances that satisfy a threshold distance. The search system 110 may identify the one or more of the media vectors that are closest to the query vector in the vector space based on determining the one or more of the Euclidean distances that satisfy the threshold distance.

In some implementations, the search system 110 may identify the media vectors that are closest to the query vector by using cosine similarity in the vector space. Cosine similarity measures a cosine of an angle between two vectors, providing a measure of similarity irrespective of the magnitudes of the vectors. Additionally, or alternatively, the search system 110 may identify the media vectors that are closest to the query vector by employing a nearest neighbor search model. A nearest neighbor search model may be efficient for identifying the closest points in high-dimensional spaces. Additionally, or alternatively, the search system 110 may identify the media vectors that are closest to the query vector by utilizing hierarchical clustering to group and identify the media vectors closest to the query vector. Hierarchical clustering may identify clusters of similar vectors, enhancing the accuracy of finding relevant media vectors.

Additionally, or alternatively, the search system 110 may identify the media vectors that are closest to the query vector by using a k-nearest neighbors model to find the media vectors that are most similar to the query vector. The k-nearest neighbors model may be effective in classification and regression tasks by identifying k closest points. Additionally, or alternatively, the search system 110 may identify the media vectors that are closest to the query vector by calculating Manhattan distances between the query vector and the media vectors to identify the closest matches. A Manhattan distance, also known as an L1 distance, may measure absolute differences along each dimension. Additionally, or alternatively, the search system 110 may identify the media vectors that are closest to the query vector by applying a support vector machine (SVM) model to classify and identify the closest media vectors to the query vector. An SVM model may be effective in high-dimensional spaces and may be used for both classification and regression tasks.

As further shown in FIG. 1G, and by reference number 165, the search system 110 may determine one or more of the media summaries that correspond to the one or more of the media vectors. For example, once the closest one or more of the media vectors are identified, the search system 110 may retrieve the media summaries associated with the closest one or more media vectors. The one or more of the media summaries may represent portion of the media files that are most relevant to the input query based on the contextual and semantic analysis performed by the vector model. The one or more of the media summaries may include key information that matches an intent of the input query, facilitating an accurate and efficient response to the search request.

Additionally, or alternatively, the search system 110 may utilize a summarization model to refine the one or more of the media summaries corresponding to the one or more of the media vectors. A summarization model may distill essential information from the one or more of the media summaries. Additionally, or alternatively, the search system 110 may utilize full-text matching within the time windows associated to determine the one or more of the media summaries. Full-text matching may ensure that the one or more of the media summaries are highly relevant to the input query. Additionally, or alternatively, the search system 110 may generate a ranked list of media summaries based on relevance scores associated with the input query, and may determine the one or more of the media summaries based on the ranked list. Ranking the media summaries may prioritize the most relevant content for the input query.

As shown in FIG. 1H, and by reference number 170, the search system 110 may expand time windows associated with the one or more of the media summaries to identify additional media summaries. For example, the search system 110 may take the time windows linked to the one or more of the media summaries and extend the time windows both before and after original time slots. The expansion of the time windows may enable the search system 110 to capture more context (e.g., the additional media summaries) and potentially relevant information surrounding the one or more of the media summaries. By incorporating the expanded time windows, the search system 110 may ensure that any segments of the media files that might have been split or overlooked during initial sampling are now included in the analysis. Additionally, the expanded time windows may facilitate more comprehensive and accurate media summaries, ensuring that the entire relevant context is considered for generating a response.

As further shown in FIG. 1H, and by reference number 175, the search system 110 may combine the one or more of the media summaries and the additional media summaries to generate a response to the input query. For example, after identifying the additional media summaries from the expanded time windows, the search system 110 may integrate the additional media summaries with the one or more of the media summaries to form a cohesive and detailed response that addresses the input query more effectively. The response may enhance the overall utility and accuracy of the search results, thereby improving user satisfaction and efficiency in locating specific information within media files. In some implementations, the search system 110 may generate a report identifying the one or more of the media summaries, one or more of the time windows associated with the one or more of the media summaries, and a contextual relevance of the one or more of the media summaries to the input query. The search system 110 may then provide options to navigate directly to the one or more of the time windows associated with the one or more of the media summaries.

As shown in FIG. 1I, and by reference number 180, the search system 110 may provide the response to the input query to the user device 105. For example, the search system 110 may provide the response to the user device 105, and the user device 105 may receive the response. The user device 105 may then display or playback the response, enabling the user to quickly and accurately locate the desired content within the media files. In some implementations, the search system 110 may generate a detailed report based on the one or more of the media summaries that correspond to the input query and may provide the detailed report to the user device 105. For example, the detailed report may include an in-depth analysis of the relevant media summaries, providing comprehensive insights to the user. Additionally, or alternatively, the search system 110 may compile a list of timestamps and associated media summaries that match the input query, and may provide the list to the user device 105. The list may enable the user to jump directly to the specific time points in the media files that contain the relevant information. Additionally, or alternatively, the search system 110 may identify specific segments of the media files that are relevant to the input query and may provide these segments to the user device 105. This may enable the user to view or listen to only the pertinent parts of the media files without having to sift through unrelated content.

Additionally, or alternatively, the search system 110 may create a visual timeline highlighting the relevant portions of the media files based on the input query, and may provide the visual timeline to the user device 105. The visual timeline may include an intuitive representation of where the relevant content is located within the media files. Additionally, or alternatively, the search system 110 may generate a playback sequence of the relevant media summaries and may provide the playback sequence to the user device 105 for direct access. The playback sequence may allow the user to experience the relevant portions of the media files in a continuous flow. Additionally, or alternatively, the search system 110 may include additional context or related information in the response to enhance the user's understanding, and may provide the enhanced enriched response to the user device 105. Additionally, or alternatively, the search system 110 may provide an interactive user interface for display on the user device 105, allowing the user to navigate through the relevant portions of the media files matching the input query.

In this way, the search system 110 enhances media file searchability. For example, the search system 110 may utilize artificial intelligence models, including LLMs and vector models, to provide a more nuanced contextual understanding of audio and video content, without requiring a user to search through the entire audio and video content. The search system 110 may provide semantic search capabilities that improve a precision of identifying specific phrases, dialogues, or texts within media files. The search system 110 may handle various forms of queries and may refine search techniques based on content form. The search system 110 may be applied across multiple industries for purposes such as competitive intelligence, e-learning, and content moderation. The search system 110 may optimize search operations and may minimize the need for manual intervention in media file analysis. Thus, the search system 110 may conserve computing resources, networking resources, and/or other resources that would have otherwise been consumed by requiring users to listen to an entire audio file or watch an entire video file to identify relevant sections, failing to identify relevant sections of audio and video content, handling poor user experience associated with requiring users to listen to an entire audio file or watch an entire video file to identify relevant sections, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

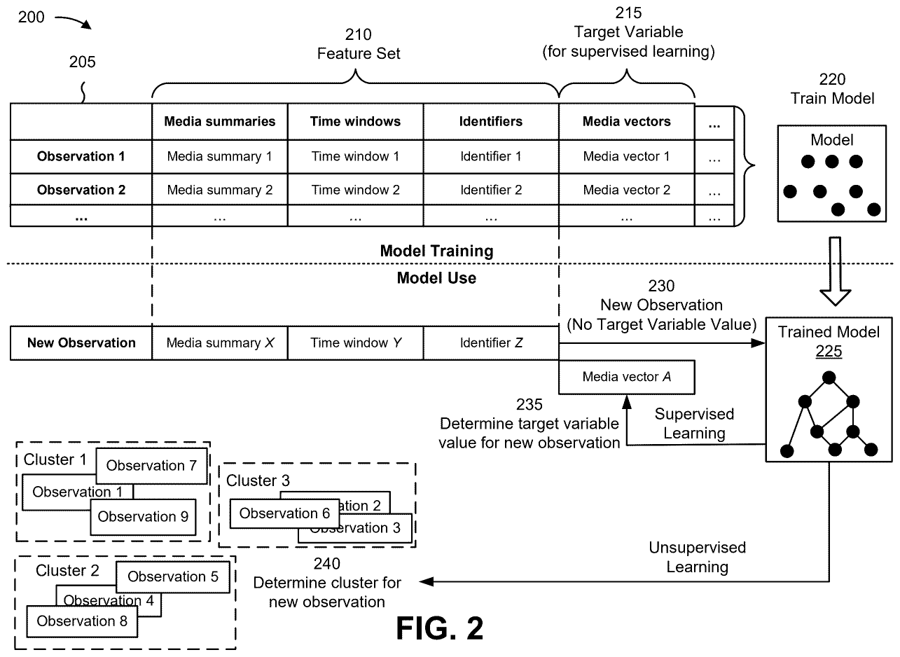

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the search system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the search system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the search system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of media summaries, a second feature of time windows, a third feature of identifiers, and so on. As shown, for a first observation, the first feature may have a value of media summary 1, the second feature may have a value of time window 1, the third feature may have a value of identifier 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “media vectors” and may include a value of media vector 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of media summary X, a second feature of time window Y, a third feature of identifier Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of media vector A for the target variable of the media vectors for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a media summaries cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a time windows cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to predict media vectors. The machine learning system enables recognition and/or identification of tens, hundreds, thousands, or millions of features and/or feature values for tens, hundreds, thousands, or millions of observations, thereby increasing accuracy and consistency and reducing delay associated with predicting media vectors relative to requiring computing resources to be allocated for tens, hundreds, or thousands of operators to manually predict media vectors.

As indicated above, FIG. 2 is provided as an example. Other examples may differ from what is described in connection with FIG. 2.

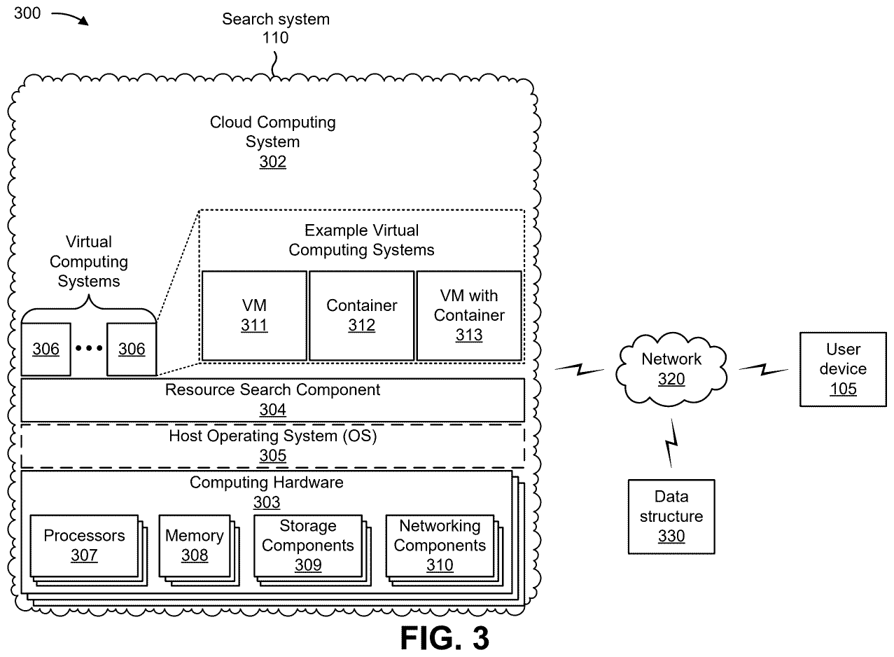

FIG. 3 is a diagram of an example environment 300 in which systems and/or methods described herein may be implemented. As shown in FIG. 3, the environment 300 may include the search system 110, which may include one or more elements of and/or may execute within a cloud computing system 302. The cloud computing system 302 may include one or more elements 303-313, as described in more detail below. As further shown in FIG. 3, the environment 300 may include a user device 105, a network 320, and/or a data structure 330. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a smartphone, a noise meter, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

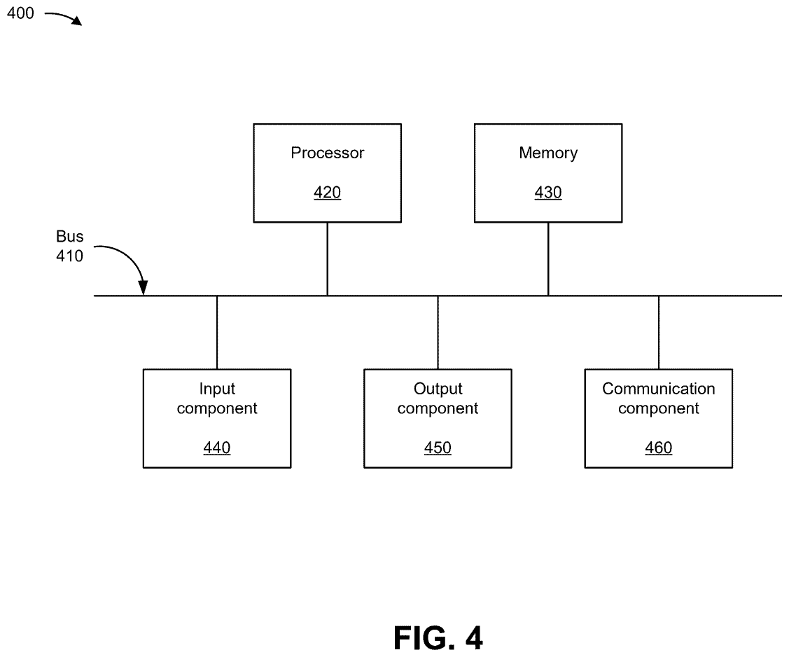

Although the search system 110 may include one or more elements 303-313 of the cloud computing system 302, may execute within the cloud computing system 302, and/or may be hosted within the cloud computing system 302, in some implementations, the search system 110 may not be cloud-based (e.g., may be implemented outside of a cloud computing system) or may be partially cloud-based. For example, the search system 110 may include one or more devices that are not part of the cloud computing system 302, such as a device 400 of FIG. 4, which may include a standalone server or another type of computing device. The search system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105, the search system 110, and/or the data structure 330. In some implementations, the user device 105, the search system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

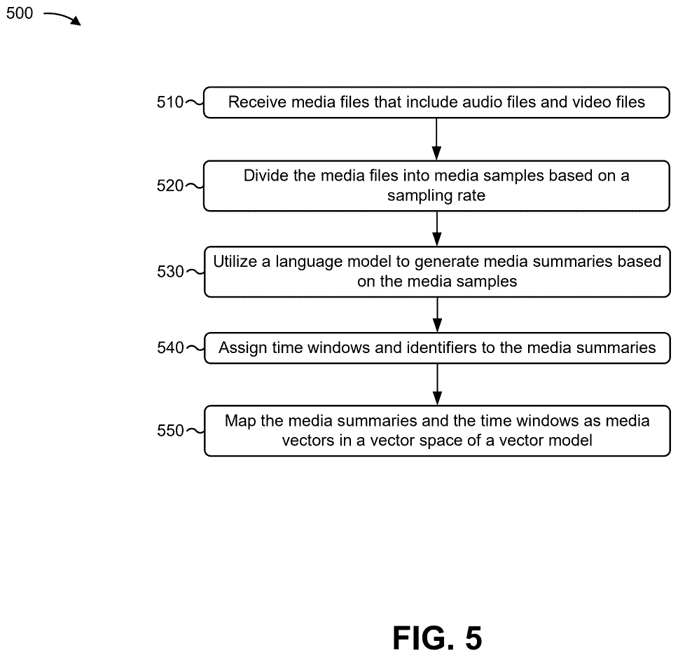

FIG. 5 depicts a flowchart of an example process 500 for enhancing media file searchability. In some implementations, one or more process blocks of FIG. 5 may be performed by a device (e.g., the search system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving media files that include audio files and video files (block 510). For example, the device may receive media files that include audio files and video files, as described above.

As further shown in FIG. 5, process 500 may include dividing the media files into media samples based on a sampling rate (block 520). For example, the device may divide the media files into media samples based on a sampling rate, as described above. In some implementations, the sampling rate is defined in intervals of minutes.

As further shown in FIG. 5, process 500 may include utilizing a language model to generate media summaries based on the media samples (block 530). For example, the device may utilize a language model to generate media summaries based on the media samples, as described above.

As further shown in FIG. 5, process 500 may include assigning time windows and identifiers to the media summaries (block 540). For example, the device may assign time windows and identifiers to the media summaries, as described above.

As further shown in FIG. 5, process 500 may include mapping the media summaries and the time windows as media vectors in a vector space of a vector model (block 550). For example, the device may map the media summaries and the time windows as media vectors in a vector space of a vector model, as described above. In some implementations, the vector model is an unsupervised machine learning model.

In some implementations, process 500 includes expanding one or more of the time windows associated with the one or more of the media summaries to identify additional media summaries, and combining the one or more of the media summaries and the additional media summaries to generate the response to the input query. In some implementations, expanding the one or more of the time windows associated with the one or more of the media summaries includes expanding each of the one or more time windows to include additional time before and after the one or more of the media summaries. In some implementations, process 500 includes performing a full-text match within the one or more of the time windows to identify the additional media summaries.

In some implementations, process 500 includes storing the media vectors of the vector model in a data structure based on the identifiers. In some implementations, process 500 includes providing the response to the input query to a user device that generated the input query. In some implementations, process 500 includes utilizing a reinforcement learning model to determine the sampling rate prior to dividing the media files into media samples based on the sampling rate.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

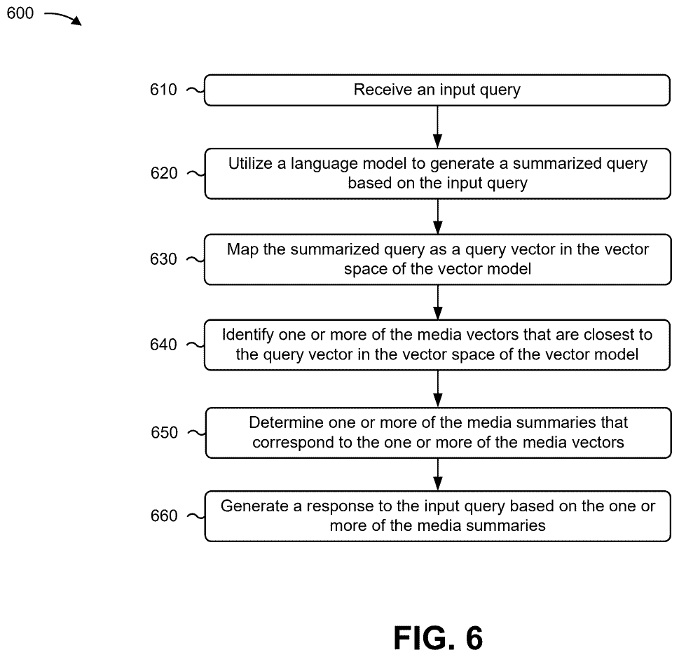

FIG. 6 depicts a flowchart of an example process 600 for enhancing media file searchability. In some implementations, one or more process blocks of FIG. 6 may be performed by a device (e.g., the search system 110). In some implementations, one or more process blocks of FIG. 6 may be performed by another device or a group of devices separate from or including the device, such as a user device (e.g., the user device 105). Additionally, or alternatively, one or more process blocks of FIG. 6 may be performed by one or more components of the device 400, such as the processor 420, the memory 430, the input component 440, the output component 450, and/or the communication component 460.

As shown in FIG. 6, process 600 may include receiving an input query (block 610). For example, the device may receive an input query, as described above. In some implementations, the input query includes one of a text query, an audio query, or a video query.

As further shown in FIG. 6, process 600 may include utilizing the language model to generate a summarized query based on the input query (block 620). For example, the device may utilize the language model to generate a summarized query based on the input query, as described above.

As further shown in FIG. 6, process 600 may include mapping the summarized query as a query vector in the vector space of the vector model (block 630). For example, the device may map the summarized query as a query vector in the vector space of the vector model, as described above.

As further shown in FIG. 6, process 600 may include identifying one or more of the media vectors that are closest to the query vector in the vector space of the vector model (block 640). For example, the device may identify one or more of the media vectors that are closest to the query vector in the vector space of the vector model, as described above. In some implementations, identifying the one or more of the media vectors that are closest to the query vector in the vector space includes calculating Euclidean distances between the query vector and the media vectors in the vector space, and identifying the one or more of the media vectors that are closest to the query vector based on the Euclidean distances. In some implementations, identifying the one or more of the media vectors that are closest to the query vector in the vector space includes calculating Euclidean distances between the query vector and the media vectors in the vector space, determining one or more of the Euclidean distances that satisfy a threshold distance, and identifying the one or more of the media vectors that are closest to the query vector in the vector space based on determining the one or more of the Euclidean distances that satisfy the threshold distance.

As further shown in FIG. 6, process 600 may include determining one or more of the media summaries that correspond to the one or more of the media vectors (block 650). For example, the device may determine one or more of the media summaries that correspond to the one or more of the media vectors, as described above.

As further shown in FIG. 6, process 600 may include generating a response to the input query based on the one or more of the media summaries (block 660). For example, the device may generate a response to the input query based on the one or more of the media summaries, as described above. In some implementations, generating the response to the input query based on the one or more of the media summaries includes generating a report identifying the one or more of the media summaries, one or more of the time windows associated with the one or more of the media summaries, and a contextual relevance of the one or more of the media summaries to the input query, and providing options to navigate directly to the one or more of the time windows associated with the one or more of the media summaries.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, media files that include audio files and video files;
dividing, by the device, the media files into media samples based on a sampling rate;
utilizing, by the device, a language model to generate media summaries based on the media samples;
assigning, by the device, time windows and identifiers to the media summaries; and
mapping, by the device, the media summaries and the time windows as media vectors in a vector space of a vector model.

2. The method of claim 1, further comprising:
receiving an input query;
utilizing the language model to generate a summarized query based on the input query;
mapping the summarized query as a query vector in the vector space of the vector model;
identifying one or more of the media vectors that are closest to the query vector in the vector space of the vector model;
determining one or more of the media summaries that correspond to the one or more of the media vectors; and
generating a response to the input query based on the one or more of the media summaries.

3. The method of claim 2, further comprising:
providing the response to the input query to a user device that generated the input query.

4. The method of claim 2, further comprising:
expanding one or more of the time windows associated with the one or more of the media summaries to identify additional media summaries; and
combining the one or more of the media summaries and the additional media summaries to generate the response to the input query.

5. The method of claim 4, wherein expanding the one or more of the time windows associated with the one or more of the media summaries comprises:
expanding each of the one or more time windows to include additional time before and after the one or more of the media summaries.

6. The method of claim 4, further comprising:
performing a full-text match within the one or more of the time windows to identify the additional media summaries.

7. The method of claim 1, further comprising:
storing the media vectors of the vector model in a data structure based on the identifiers.

8. A device, comprising:
one or more processors configured to:
receive media files that include audio files and video files;
divide the media files into media samples based on a sampling rate;
utilize a language model to generate media summaries based on the media samples;
assign time windows and identifiers to the media summaries;
map the media summaries and the time windows as media vectors in a vector space of a vector model;
receive an input query;
utilize the language model to generate a summarized query based on the input query;
map the summarized query as a query vector in the vector space of the vector model;
identify one or more of the media vectors that are closest to the query vector in the vector space of the vector model;
determine one or more of the media summaries that correspond to the one or more of the media vectors;
generate a response to the input query based on the one or more of the media summaries; and
provide the response to the input query to a user device that generated the input query.

9. The device of claim 8, wherein the one or more processors, to identify the one or more of the media vectors that are closest to the query vector in the vector space, are configured to:
calculate Euclidean distances between the query vector and the media vectors in the vector space; and
identify the one or more of the media vectors that are closest to the query vector based on the Euclidean distances.

10. The device of claim 8, wherein the input query includes one of a text query, an audio query, or a video query.

11. The device of claim 8, wherein the vector model is an unsupervised machine learning model.

12. The device of claim 8, wherein the one or more processors are further configured to:
utilize a reinforcement learning model to determine the sampling rate prior to dividing the media files into media samples based on the sampling rate.

13. The device of claim 8, wherein the one or more processors, to identify the one or more of the media vectors that are closest to the query vector in the vector space, are configured to:
calculate Euclidean distances between the query vector and the media vectors in the vector space;
determine one or more of the Euclidean distances that satisfy a threshold distance; and
identify the one or more of the media vectors that are closest to the query vector in the vector space based on determining the one or more of the Euclidean distances that satisfy the threshold distance.

14. The device of claim 8, wherein the one or more processors, to generate the response to the input query based on the one or more of the media summaries, are configured to:
generate a report identifying the one or more of the media summaries, one or more of the time windows associated with the one or more of the media summaries, and a contextual relevance of the one or more of the media summaries to the input query; and
provide options to navigate directly to the one or more of the time windows associated with the one or more of the media summaries.

15. A non-transitory computer-readable medium storing a set of instructions, the set of instructions comprising:
one or more instructions that, when executed by one or more processors of a device, cause the device to:
receive media files that include audio files and video files;
divide the media files into media samples based on a sampling rate;
utilize a language model to generate media summaries based on the media samples;
assign time windows and identifiers to the media summaries;
map the media summaries and the time windows as media vectors in a vector space of a vector model;
store the media vectors of the vector model in a data structure based on the identifiers;
receive an input query;
utilize the language model to generate a summarized query based on the input query;
map the summarized query as a query vector in the vector space of the vector model;
identify one or more of the media vectors that are closest to the query vector in the vector space of the vector model;
determine one or more of the media summaries that correspond to the one or more of the media vectors; and
generate a response to the input query based on the one or more of the media summaries.

16. The non-transitory computer-readable medium of claim 15, wherein the one or more instructions further cause the device to:
expand one or more of the time windows associated with the one or more of the media summaries to identify additional media summaries; and
combine the one or more of the media summaries and the additional media summaries to generate the response to the input query.

17. The non-transitory computer-readable medium of claim 16, wherein the one or more instructions, that cause the device to expand the one or more of the time windows associated with the one or more of the media summaries, cause the device to:
expand each of the one or more time windows to include additional time before and after the one or more of the media summaries.

18. The non-transitory computer-readable medium of claim 15, wherein the one or more instructions further cause the device to:
provide the response to the input query to a user device that generated the input query.

19. The non-transitory computer-readable medium of claim 15, wherein the one or more instructions, that cause the device to identify the one or more of the media vectors that are closest to the query vector in the vector space, cause the device to:
calculate Euclidean distances between the query vector and the media vectors in the vector space; and
identify the one or more of the media vectors that are closest to the query vector based on the Euclidean distances.

20. The non-transitory computer-readable medium of claim 15, wherein the one or more instructions further cause the device to:
utilize a reinforcement learning model to determine the sampling rate prior to dividing the media files into media samples based on the sampling rate.
